(19) United States
(12) Patent Application Publication
(10) Pub. No.: US 2026/0178694 A1
(43) Pub. Date: Jun. 25, 2026

(54) BOOLEAN MATRIX FACTORIZATION FOR LUT-BASED NEURAL NETWORKS

(71) Applicant: XILINX, INC., San Jose, CA (US)

(72) Inventors: Linus Matthias WITSCHEN, Dublin (IE); Nicholas FRASER, Co. Dublin (IE); Yaman UMUROGLU, Stockholm (SE); Thomas Bernd PREUSSER, Dresden (DE); Michaela BLOTT, Dublin (IE)

(21) Appl. No.: 19/000,991

(22) Filed: Dec. 24, 2024

(51) Int. Cl. G06F 17/16; G06F 1/03

(52) U.S. Cl. CPC G06F 17/16; G06F 1/03

(57) ABSTRACT

Embodiments herein relate to applying a Boolean matrix factorization operation to selected neurons, represented as truth tables, in LUT based neural networks. Applying the Boolean matrix factorization operation replaces the original truth table representing the neuron of the neural network with a simplified, approximated truth table derived from the original truth table. The neural network is then simulated, and the cost of the simulated result, as evaluated by a cost function which may for instance incorporate accuracy and resource cost, is compared to a cost threshold value to decide whether to replace the original neuron with its approximated representation.

### TECHNICAL FIELD

The embodiments presented relate to look-up table (LUT) based neural networks. LUT based neural networks implement mathematical operations using precomputed LUTs or truth tables. The truth tables represent neurons of the neural network and can store the outputs of neural network operations such as activations, weight multiplications, etc.

### BACKGROUND

LUT based hardware implementations of machine learning applications (e.g., neural network implementations on field programmable gate arrays (FPGAs)) can be highly efficient and can achieve very high throughput at extremely low latencies. However, a challenge in the design process is to meet the constraints on resource utilization to accommodate the design on a single hardware platform while achieving a target performance.

### SUMMARY

According to some embodiments, a method including: selecting a neuron from a look-up table (LUT) based neural network, wherein the neuron is represented as a first truth table; applying a Boolean matrix factorization (BMF) operation to the first truth table that represents the neuron, wherein the BMF operation generates a second truth table; and replacing the first truth table as the representation of the neuron in the LUT based neural network with the second truth table.

According to some embodiments, a system including: one or more processors; and one or more memories configured to store an application, which, when executed by a combination of the one or more processors, causes the combination of the one or more processors to perform an operation, the operation including: selecting a neuron from a look-up table (LUT) based neural network, wherein the neuron is represented as a first truth table; applying a Boolean matrix factorization (BMF) operation to the first truth table that represents the neuron, wherein the BMF operation generates a second truth table; and replacing the first truth table as the representation of the neuron in the LUT based neural network with the second truth table.

According to some embodiments, a computer-readable storage medium having computer-readable program code embodied therewith, the computer-readable program code executable by one or more computer processors to perform operations including: selecting a neuron from a look-up table (LUT) based neural network, wherein the neuron is represented as a first truth table; applying a Boolean matrix factorization (BMF) operation to the first truth table that represents the neuron, wherein the BMF operation generates a second truth table; and replacing the first truth table as the representation of the neuron in the LUT based neural network with the second truth table.

### BRIEF DESCRIPTION OF DRAWINGS

FIG. 1 illustrates a neuron simplification system, according to some embodiments.

FIG. 2 illustrates a flow diagram for simplifying neurons, according to some embodiments.

FIG. 3 illustrates a Boolean matrix factorization operation, according to some embodiments.

FIG. 4 illustrates implementing the neuron simplifier in a neural network, according to some embodiments.

### DETAILED DESCRIPTION

Embodiments herein relate to a simplification system for neurons of LUT based neural networks. The challenges of LUT based neural networks include meeting computational constraints while maintaining accuracy. Though LUT based neural networks can already alleviate the computational load via the implementation of look-up tables, the lookup tables can be further simplified to further improve the computing system's efficiency. Embodiments herein relate to applying a Boolean matrix factorization operation to selected neurons (e.g., truth tables), in LUT based neural networks. Applying the Boolean matrix factorization operation replaces the original truth table representing the neuron with a simplified, approximated truth table derived from the original truth table. The degree of factorization of the Boolean matrix operation is a user-customizable parameter. The truth table is simplified as the Boolean matrix factorization operation outputs a simplified, compressed version of the original truth table. The neural network is then simulated and the accuracy of the simulated result is compared to an accuracy target threshold value. If the accuracy of the simulated result is within an acceptable range of the target threshold value, the approximated truth table deviated from the original truth table is maintained as the replacement of the original truth table. If the accuracy of the simulated result is not within an acceptable range of the threshold value, the representation of the neuron is reverted back to the previous truth table.

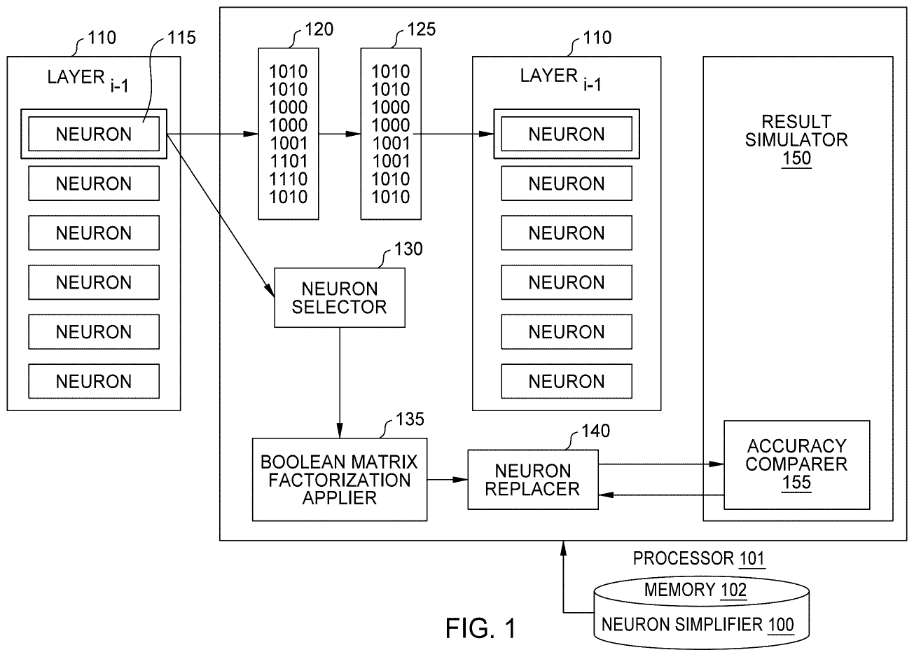

FIG. 1 illustrates a neuron simplifier 100 which can be implemented on a computing system with a processor 101, and a memory 102. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 102 generally includes program code for performing various functions related to use of the neuron simplifier 100. The program code is generally described as various functional “applications” or “modules” within the memory 102, although alternate implementations may have different functions and/or combinations of functions. Within the memory 102, the neuron simplifier 100 constrains values of the quantized neural network, improving efficiency and accuracy of neural networks, which is discussed in further detail below.

The neural network layer 110 contains neurons, such as neuron 115. The neural network layer 110 is part of a LUT based neural network, where the layer 110 contains neurons such as neuron 115, which is represented as a precomputed truth table 120. The neuron 115 uses inputs from previous layers of the network as indices to look up precomputed values from the truth table 120. This reduces the computational load by converting runtime operations into fast memory accesses. When the neuron 115 receives an input, it retrieves a corresponding output from the truth table 120 where the input is used to perform a look-up operation into the truth table 120, rather than performing calculations. To further increase efficiency, embodiments herein explore an approximation method that makes the implementation of the truth table less computationally expensive. Boolean matrix factorization reduces computational expense by decomposing the original truth table into lower-rank matrices that use less storage. This compressed representation reduces memory access and computation, especially for large truth tables with redundant patterns. The truth table generated via Boolean matrix factorization may have a reduced variation amongst its values compared to the variation of values in the original truth table.

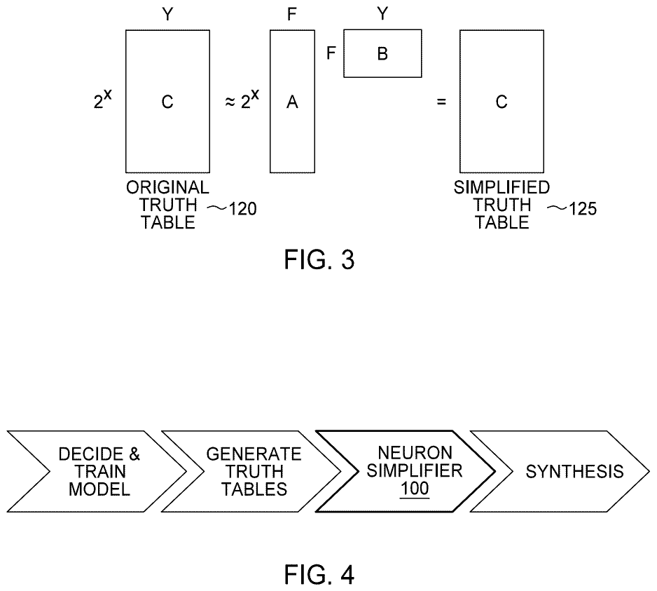

The neuron selector 130 of the neuron simplifier 100 selects the neuron 115 from the layer 110 of the LUT based neural network. In some embodiments, the neuron selector 130 iterates through each neuron in the layer 110. The neuron 115 is represented by the truth table 120. Within the neuron simplifier 100, the Boolean matrix factorization applier 135 applies a Boolean matrix factorization operation to the truth table 120. The applied Boolean matrix factorization operation generates an approximated, simplified, truth table 125 derived from the first, original truth table. The second, simplified truth table 125 may implement a simpler logic function than in the original truth table 120. The Boolean matrix factorization operation is described in more detail in FIG. 3.

Once the second, simplified truth table 125 is generated, the neuron replacer 140 replaces the first truth table 120 as the representation of the neuron 115 in the LUT based neural network with the second truth table 125.

Once the replacement has been made by the neuron replacer 140, the result simulator 150 simulates the neural network. The result simulator 150 aims to verify the accuracy, performance, hardware area, and other varying metrics, of the updated neural network using its accuracy comparer 155.

The simulation process can involve testing the trained neural network in a software environment to measure accuracy, behavior, and performance under various conditions. The result simulator 150 helps identify potential issues and ensures the model works as expected before it is committed to hardware synthesis, at a synthesis module. The synthesis module includes converting the LUT based neural network into a format suitable for implementation on hardware.

The result simulator 150 can perform different types of simulations.

For example, it may perform a software-based simulation which simulates the neural network in a software framework, such as the software framework where the neural network was designed and trained. In this environment, the neural network can be tested by receiving unseen test data. The accuracy comparer 155 can measure the accuracy of the neural network that contains the simplified truth table 125 to ensure performance criteria, such as a threshold accuracy level, have been met. If the accuracy comparer 155 determines that the threshold accuracy level of the neural network has not been or would not be met with the second truth table 125 representing the neuron 115, the neuron replacer 140 reverts the representation of the neuron from the second truth table 125 back to the first truth table 120.

In some embodiments, quantization and/or hardware-aware approximation is used. Quantization and hardware-aware approximation involve approximating the way the neural network will behave in a low-precision or resource-constrained environment. This can include quantizations, where the floating-point weights, activations, and/or biases of the network are reduced to a lower precision. Quantization can affect the neural network's accuracy. Quantization and hardware-aware approximation help evaluate the impact of reduced precision on performance.

Additionally, the result simulator 150 may simulate the neural network's behavior in a hardware-aware context using behavioral models. Such models can mimic the ways the neural network will function on the target hardware architecture. The accuracy comparer 155 can detect whether the accuracy level drops below a target value and revert the neuron's 115 representation to the original truth table 120 if the target accuracy is not met.

The result simulator 150 uses the accuracy comparer 155 after simulating the hardware and/or software behavior of the neural network. The accuracy comparer may perform a functional verification to ensure the hardware-or software-simulated network produces results that meet a predetermined or adjustable cost function level/score.

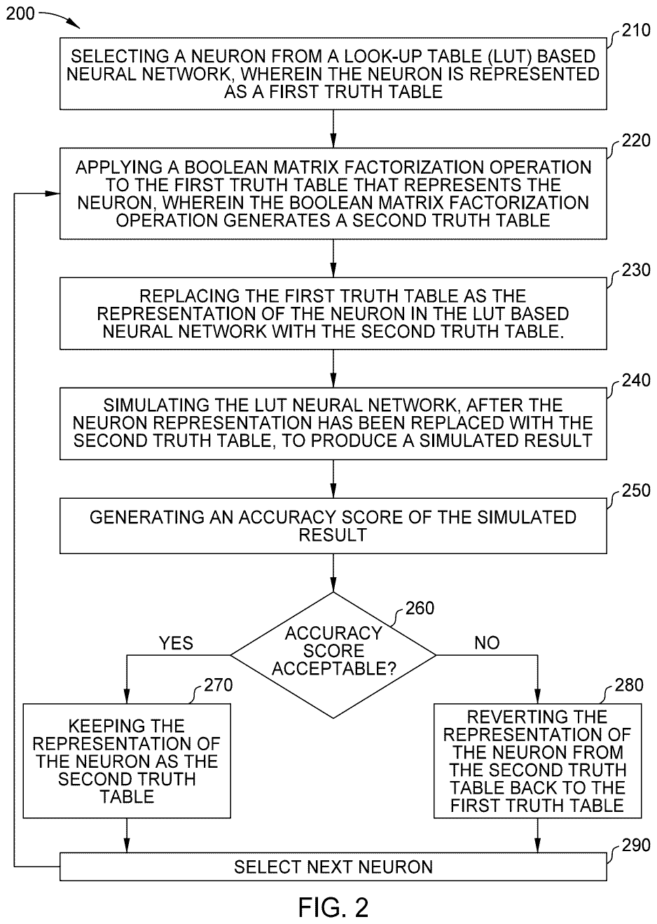

FIG. 2 illustrates a flowchart 200 of the neuron simplifier 100.

At block 210, the neuron selector 130 selects a plurality of neurons 115 from the layer 110 of the LUT based neural network. The selected neuron 115 is represented as a truth table 120. In some embodiments, selecting a neuron, such as neuron 115, involves identifying a neuron with a truth table representation. The neuron selector may select the neuron after recognizing that its truth table representation is capable of being reduced or meeting certain criteria. Example criteria can include identifying neurons with inputs that do not significantly affect their output, meaning their activation function can be approximated, or their input values can be grouped to share output values without significantly impacting accuracy. Criteria can include and combine the internals of the truth table as well as the preceding and succeeding structures in the neural network. For example, a truth table that encodes a complex logic function could be targeted for simplification to reduce the neuron's complexity to simplify the resulting hardware structure. Considering the preceding and succeeding network structure, such as the size of the fanin cone, fanout cone, or the maximum fanout-free cone, enables simplifications to propagate through the network, potentially simplifying greater parts of the logic rather than just the simplified neuron.

In other embodiments, all neurons on the layer may be selected by the neuron selector 130, but at different iterations of the method 200.

At block 220, the Boolean matrix factorization applier 135 applies a Boolean matrix factorization operation to the selected neuron's truth table representation. Boolean matrix factorization is a mathematical technique used to approximate a Boolean matrix by factoring the original Boolean matrix into two or more smaller matrices. Boolean matrix factorization helps decompose a large and complex truth table into simpler structures, reducing the storage and computation overhead for look-up table implementations in neural networks.

In one embodiment, the truth table representation of the selected neuron can be viewed as a Boolean matrix where the rows represent different input combinations and the columns represent the output or intermediate states of the neuron. The entries of the matrix may be either 0 or 1, indicating whether a particular input combination is a false or true output. Storing and processing the truth table representation of complex systems is expensive because the size of a truth table grows exponentially with the number of its inputs.

Boolean matrix factorization can break the large matrix into relatively smaller factors which approximate the original truth table while preserving the structure. This allows for a more compact representation. For example, if the truth table has redundant or overlapping patterns of inputs and outputs, Boolean matrix factorization can exploit these patterns to create smaller, more manageable matrices.

When applied to truth tables, Boolean matrix factorization operations simplify the representation of the truth table by capturing regularities or repeating patterns in the input-output relationships. For instance, if several rows in the truth table produce the same or similar outputs for different inputs, Boolean matrix factorization can identify these patterns and compress them into a smaller set of factors.

At block 230, the neuron replacer 140 replaces the first, original, selected truth table representation of the neuron with the second truth table generated via the applied Boolean matrix factorization.

At block 240, the result simulator 150 simulates the neural network after the neuron representation has been replaced with the second truth table to produce a simulated result. As discussed in FIG. 1, the simulation process can involve testing the trained neural network in a software environment to measure accuracy, behavior, and performance under various conditions. The result simulator 150 helps identify potential issues and ensures the model works as expected before it is committed to hardware synthesis.

The result simulator 150 can perform different types of simulations.

For example, it may perform a software-based simulation. A software-based simulation simulates the neural network in a software framework, such as where the neural network was designed and trained. In this environment, the neural network can be tested by receiving unseen test data. The accuracy comparer 155 can measure the accuracy of the neural network that contains the second, updated truth table 125 to ensure performance criteria, such as a threshold accuracy level, have been met. If the accuracy comparer 155 determines that the threshold accuracy level of the neural network has not been or would not be met with the second truth table 125 representing the neuron 115, the neuron replacer 140 reverts the representation of the neuron from the second truth table back to the first truth table.

Additionally, the result simulator 150 may simulate the neural network's behavior in a hardware-aware context using behavioral models. Such models can mimic the ways the neural network will function on the target hardware architecture.

At block 250 the accuracy comparer 155 generates a cost function score that, for example, incorporates the achieved accuracy. Determining the accuracy can involve running the network on a set of test data and comparing its predictions to the true labels. The cost function score can quantify how well the network performs by measuring the percentage of correct predictions based on the generated cost function score.

At decision block 260, the accuracy comparer determines whether the accuracy level drops below a target value.

The result simulator 150 uses the accuracy comparer 155 after simulating the hardware and/or software behavior of the neural network. The accuracy comparer may perform a functional verification to determine whether the hardware-or software-simulated network produces results that meet the predetermined or adjustable accuracy level/score. If the accuracy score presented in the simulation is acceptable, the flowchart flows to block 270. If the accuracy score presented in the simulation is not acceptable, the flowchart flows to block 280.

At block 270, the neuron replacer keeps the representation of the selected neuron as the second truth table generated from the Boolean matrix factorization operation. The second truth table is a simplified version of the first truth table with less variation in values.

At block 280, the neuron replacer reverts the representation of the neuron from the second truth table back to the first truth table.

At block 290, the flowchart moves back to block 220, where the neuron selector 130 selects the next neuron from the plurality of neurons that were selected at block 210, in the layer of the LUT based neural network.

FIG. 3 illustrates the Boolean matrix factorization operation applied to the selected neuron. For example, the Boolean matrix factorization operation shown in FIG. 3 can be used at block 220 of the method 200. The Boolean matrix factorization operation aims to simplify the truth table that represents the neuron selected in the LUT based neural network. The Boolean matrix factorization operation factorizes a binary matrix under Boolean algebra so that C^{XxY}≈A^{XxF}*B^{FxY}=C′, where C is the original truth table, X is the number of input bits, Y is the number of output bits, A and B are low-rank matrices, F is a scaling factor for the factorization, and C″ is the approximated truth table. In the Boolean matrix factorization operation, the degree of factorization, or the number of smaller Boolean matrices used to approximate the original first truth table, can be set by the user or can be found automatically by, for example, an optimization algorithm.

FIG. 4 illustrates where the neuron simplifier 100 may be applied when preparing a neural network. In embodiments herein, the neuron simplifier is implemented on LUT-based neural networks that are already trained with generated truth tables, but before the neural network enters a synthesis phase. The synthesis phase of a neural network refers to the process of converting the trained model into a format that can be implemented on hardware such as a field-programmable gate array (FPGA), an application-specific integrated circuit (ASIC), or an embedded system, among other things. This can involve taking the neural network's high-level, software-based model and translating it into a hardware description that defines its components, connections, and operations in a way that is compatible with the target platform. During synthesis, optimizations can be applied to make the neural network more suitable for real-time or resource constrained applications. The neuron simplifier 100 is applied to the neural network, and it is then sent to a synthesis phase.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
selecting a neuron from a look-up table (LUT) based neural network, wherein the neuron is represented as a first truth table;
applying a Boolean matrix factorization (BMF) operation to the first truth table that represents the neuron, wherein the BMF operation generates a second truth table; and
replacing the first truth table as the representation of the neuron in the LUT based neural network with the second truth table.

2. The method of claim 1, further comprising:
simulating the LUT based neural network, after the neuron representation has been replaced with the second truth table, to produce a simulated result;
generating a cost function score; and
comparing the cost function score to a target threshold.

3. The method of claim 2, further comprising:
determining the cost function score does not meet the target threshold; and
reverting the representation of the neuron from the second truth table back to the first truth table.

4. The method of claim 1 further comprising sending the LUT based neural network to a synthesis module, wherein the synthesis module includes converting the LUT based neural network into a format suitable for implementation on hardware.

5. The method of claim 1, wherein the second truth table is a simplified version of the first truth table with less variation in values.

6. The method of claim 1, wherein the LUT based neural network has previously been trained before applying the BMF operation.

7. The method of claim 1, wherein a degree of factorization of the BMF operation is a user-customizable parameter.

8. A system comprising:
one or more processors; and
one or more memories configured to store an application, which, when executed by a combination of the one or more processors, causes the combination of the one or more processors to perform an operation, the operation comprising:
selecting a neuron from a look-up table (LUT) based neural network, wherein the neuron is represented as a first truth table;
applying a Boolean matrix factorization (BMF) operation to the first truth table that represents the neuron, wherein the BMF operation generates a second truth table; and
replacing the first truth table as the representation of the neuron in the LUT based neural network with the second truth table.

9. The system of claim 8, further comprising:
simulating the LUT based neural network, after the neuron representation has been replaced with the second truth table, to produce a simulated result;
generating a cost function score; and
comparing the cost function score to a target threshold.

10. The system of claim 9, further comprising:
determining the cost function score does not meet the target threshold; and
reverting the representation of the neuron from the second truth table back to the first truth table.

11. The system of claim 8 further comprising sending the LUT based neural network to a synthesis module, wherein the synthesis module includes converting the LUT based neural network into a format suitable for implementation on hardware.

12. The system of claim 8, wherein the second truth table is a simplified version of the first truth table with less variation in values.

13. The system of claim 8, wherein the LUT based neural network has previously been trained before applying the BMF operation.

14. The system of claim 8, wherein a degree of factorization of the BMF operation is a user-customizable parameter.

15. A computer-readable storage medium having computer-readable program code embodied therewith, the computer-readable program code executable by one or more computer processors to perform operations comprising:
selecting a neuron from a look-up table (LUT) based neural network, wherein the neuron is represented as a first truth table;
applying a Boolean matrix factorization (BMF) operation to the first truth table that represents the neuron, wherein the BMF operation generates a second truth table; and
replacing the first truth table as the representation of the neuron in the LUT based neural network with the second truth table.

16. The computer readable program code of claim 15, the operations further comprising:
simulating the LUT based neural network, after the neuron representation has been replaced with the second truth table, to produce a simulated result;
generating a cost function score; and
comparing the cost function score to a target threshold.

17. The computer readable program code of claim 16, the operations further comprising:
determining the cost function score does not meet the target threshold; and
reverting the representation of the neuron from the second truth table back to the first truth table.

18. The computer readable program code of claim 15, the operations further comprising sending the LUT based neural network to a synthesis module, wherein the synthesis module includes converting the LUT based neural network into a format suitable for implementation on hardware.

19. The computer-readable program code of claim 15, wherein the second truth table is a simplified version of the first truth table with less variation in values.

20. The computer-readable program code of claim 15, wherein the LUT based neural network has previously been trained before applying the BMF operation.
